(19) United States
(12) Patent Application Publication
(10) Pub. No.: US 2006/0166162 A1
(43) Pub. Date: Jul. 27, 2006

(54) Multifunctional dental mirror

(76) Inventor: Shao-Chieh Ting, Banchiau City (TW)

Correspondence Address: Shao-Chieh Ting, P.O. Box No. 6-57, Junghe, Taipei, 235, TW

(21) Appl. No.: 11/039,831

(22) Filed: Jan. 24, 2005

(51) Int. Cl. A61C 3/00

(52) U.S. Cl. 433/31; 433/29

(57) ABSTRACT

The present invention provides a multifunctional dental mirror, which is particularly applicable for use when examining or treating the oral cavity or teeth, and has a configuration encompassing a camera device and an LED light-source device. The light-source device projects light directly onto an intraoral viewing mirror, the light then undergoes reflection, thereby achieving effectiveness of illumination, and, in conjunction with circuitry connected to a computer or related display unit, real-time video image viewing or recording of video images from the intraoral viewing mirror is realized, which enables a user to know condition of the oral cavity or the teeth.

### BACKGROUND OF THE INVENTION

(a) Field of the Invention

The present invention relates to a multifunctional dental mirror, and more particularly to a dental mirror that enables a stomatologist or dentist to view deep into the oral cavity when examining a patient.

(b) Description of the Prior Art

Presently, the main objective of a dentist examining a patient is to examine outward appearance of the teeth and gums of the patient for abnormalities (such as: tartar, dental plaque, and so on), which is then used as a basis to make a diagnosis and determine whether or not to proceed with further medical treatment. However, because of limitations imposed by size of the oral cavity after opening the mouth, and viewing-angle related problems, thus, the dentist is unable to directly see complete condition of the oral cavity of the patient. Hence, the dentist must use a dental mirror in conjunction with a light source, which projects light into the oral cavity of the patient and onto the dental mirror, and only then can a deep and thorough examination be carried out. Such mirror devices for examining teeth require a light source positioned in an upper portion of the oral cavity of the patient. However, because the light source is fixed at a certain position, if the size of the oral cavity of the patient is too small or the head of the patient is inclined to one side, then the light source is unable to project light onto the dental mirror, and thus there is no reflection of light therefrom. Hence, because lighting is insufficient to illuminate back surface areas of the oral cavity and the teeth, thus, the dentist is unable to make an accurate diagnosis.

Furthermore, when a person wants to examine their own teeth, the person holds a mirror or other light-reflecting article to carry out a preliminary examination of their oral cavity and teeth. However, because of viewing-angle related problems, most of the surface areas of the teeth cannot be examined. Moreover, tartar and dental plaque often form because of residue left on the teeth or in crevices between the teeth, thereby resulting in decayed teeth, which the person is only aware of after toothache.

In light of the aforementioned shortcomings of conventional oral cavity dental mirrors, the inventor of the present invention directed research and development to improve such defects, and finally created the present invention.

### SUMMARY OF THE INVENTION

In light of the shortcomings of prior art, a primary objective of the present invention is to provide a multifunctional dental mirror, wherein an intraoral viewing mirror is connected to a base, and a camera device is disposed within the base, and connected to a computer or related display unit by means of a circuit board, thereby providing real-time video image viewing or storing of video images from the intraoral viewing mirror.

Another objective of the present invention is to provide the multifunctional dental mirror, wherein the intraoral viewing mirror is connected to the base by means of a stem, and light-emitting bodies disposed within the base can project light directly towards the intraoral viewing mirror.

Yet another objective of the present invention is to provide the multifunctional dental mirror, wherein the stem of the intraoral viewing mirror is affixed to a ring, which enables rotating position of the stem on a circumferential edge of the ring, thereby providing functionality that realizes adjusting different angular positions of the intraoral viewing mirror according to user requirements.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an assembled elevational view of a preferred embodiment according to the present invention.

FIG. 2 shows an exploded elevational view according to the present invention (1).

FIG. 3 shows an exploded elevational view according to the present invention (2).

FIG. 4 shows a cross-sectional schematic view according to the present invention.

FIG. 4A shows enlarged views of FIG. 4.

FIG. 4B shows enlarged views of FIG. 4.

FIG. 5 shows a cross-sectional view along line A-A of FIG. 1 according to the present invention.

### DETAILED DESCRIPTION OF THE PREFERRED EMBODIMENTS

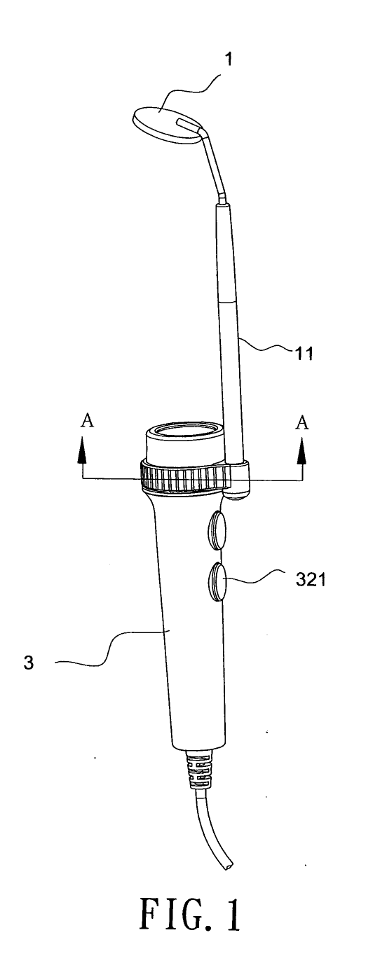

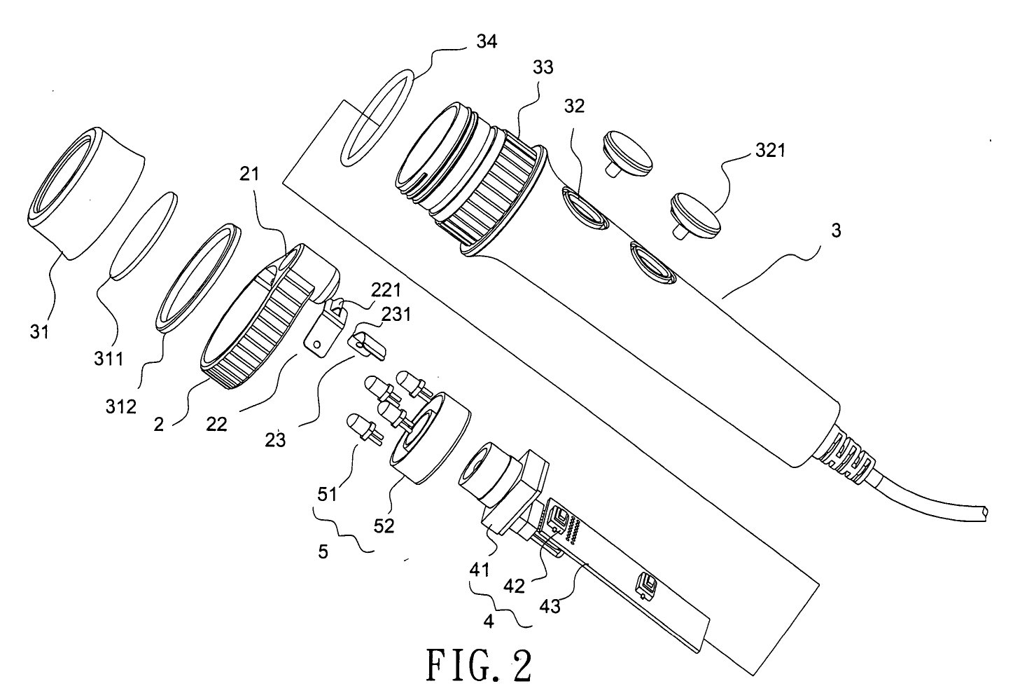

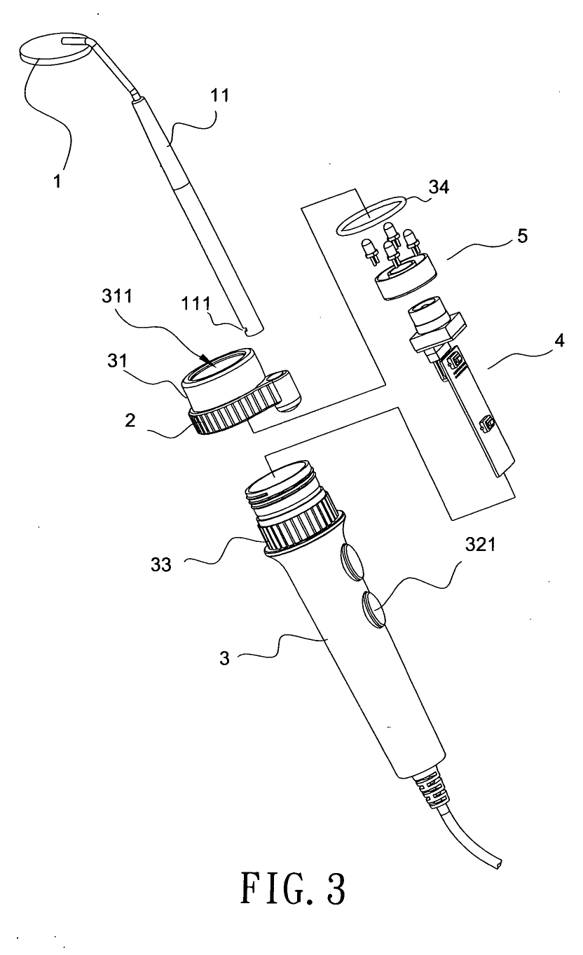

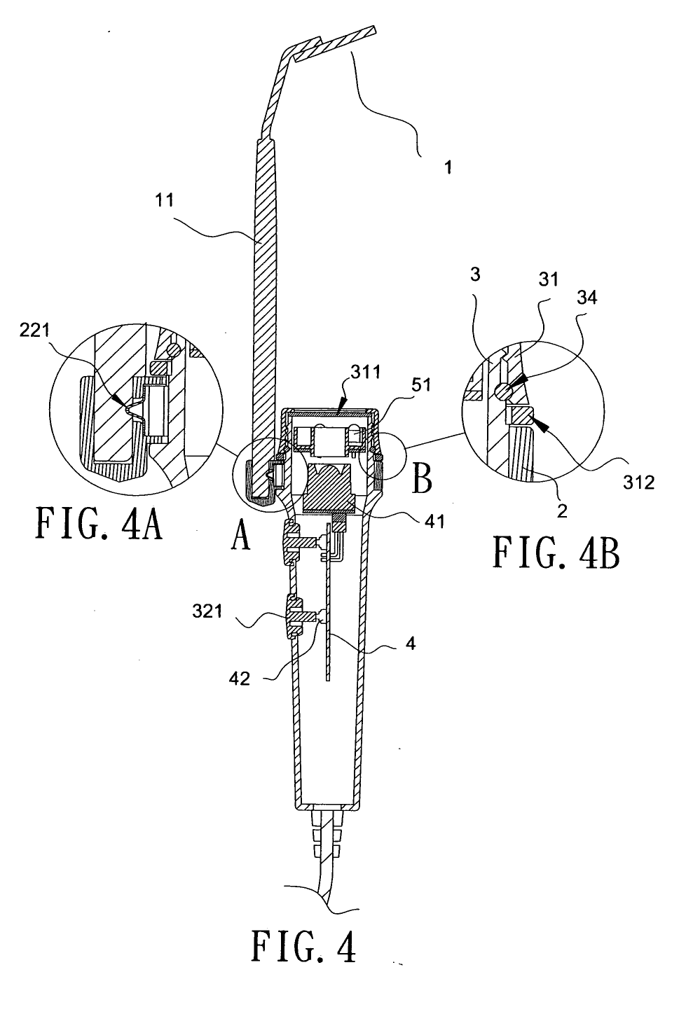

FIG. 1 shows an assembled elevational view of a preferred embodiment of the present invention, and in conjunction with the other FIGS., a multifunctional dental mirror of the present invention can be seen to comprise: an intraoral viewing mirror 1, a ring 2, a base 3, a camera device 4 and an LED (light-emitting diode) light-source device 5, wherein the intraoral viewing mirror 1 is connected to one end of a stem 11, and a groove 111 is defined in another end of the stem 11 (see FIG. 3). The ring 2 is disposed on the base 3, and a locating hole 21 is configured as an extension on a side of the ring 2, and provides for the intraoral viewing mirror 1 to be disposed and positionally fixed therein. A cover 31 is connected to the base 3, thereby forming a hollow containment cavity within the base 3, wherein electronic components are disposed. The cover 31 is an annular frame member, within which a transparent disk 311 is disposed. A water-repellent ring 34 and washer 312 are disposed between the cover 31 and the base 3, and between the cover 31 and the ring 2 respectively (see FIGS. 4, 4A, 4B). When the cover 31 is connected to the base 3, the washer 312 and the ring 34 seal gaps at joints between the cover 31 and the base 3, and between the cover 31 and the ring 2 respectively, thereby preventing moisture from entering the base 3. Furthermore, a plurality of grooves 33 are defined on a circumferential edge, which extends from an end of the base 3, as a counterpart to the ring 2 configured on the base 3. Moreover, through holes 32 are defined at appropriate positions on the base 3, and provide for push-buttons 321 to be respectively positioned therein. A camera device 4 comprises photoelectric members including a CCD (charge coupled device) 41, which respond to light. The CCD (charge coupled device) 41 is connected to a circuit board 43, upon which cutover switches 42 are configured so as to correspond to the through holes 32 of the base 3. The LED (light-emitting diode) light-source device 5 is structured to comprise at least one LED (light-emitting diode) 51 disposed on a light mount 52, and the LEDs 51 are connected to the circuit board 43.

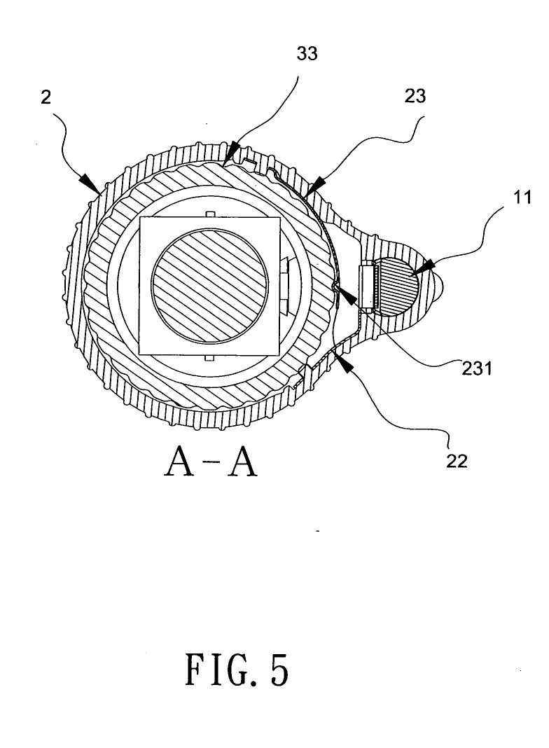

When assembling the multifunctional dental mirror of the present invention, the transparent disk 311 is first disposed within the cover 31, and a catch member 221 of an elastic piece 22, which is one of two elastic pieces 22, 23 attached to an inner edge of the ring 2, is then inserted into the locating hole 21 of the ring 2. When the stem 11 of the intraoral viewing mirror I is inserted into the locating hole 21 of the ring 2, the catch member 221 clips into the groove 111 on the stem 11, thereby fixing position of the stem 11. A catch member 231 on the elastic piece 23 clips into one of the grooves 33 on he base 3 (see FIG. 5), thereby providing an elastic catch force, which enables freely displacing position of the intraoral viewing mirror 1 on the circumferential edge of the base 3 by manipulating disposition of the ring 2. Such a configuration enables the left hand or the right hand of a user to manipulate the present invention or to adjust angular position of the intraoral viewing mirror 1 on the base 3, thereby achieving a configuration that conforms to ergonomics. Moreover, the camera device 4 and the LED light-source device 5 are respectively disposed within the base 3 so that the cutover switches 42 on the circuit board 43 of the camera device 4 correspond to the push-buttons 321 in the through holes 32. After assembling the aforementioned structural members, the water-repellent ring 34 and washer 312 are disposed between the cover 31 and the base 3, and the cover 31 and the ring 2 respectively, achieving water-repellent effectiveness therewith.

When using the present invention, the push-buttons 321 on the base 3 are used to actuate the cutover switches 42 and control switching on and switching off of the camera device 4 and the LED light-source device 5. When the present invention is switched on, the LED light-source device 5 projects light through the transparent disk 311 and onto the intraoral viewing mirror 1, which then reflects the light, thereby facilitating illumination of back surface areas of the oral cavity and teeth. Moreover, the CCD (charge coupled device) 41 photoelectric member of the camera device 4 simultaneously responds to the reflected light, and produces different currents that are converted into “digital code” through an analog digital converter. Images from the camera device 4 are transmitted to a computer or other display unit by means of a connecting cable, thereby enabling displaying or storing of the images for convenient viewing by a user.

In conclusion, the multifunctional dental mirror of the present invention not only provides the LED light-source device 5 for projecting light that enables medical personnel to easily examine condition of oral cavity or teeth of a patient, moreover, extends functionality for real-time video image photography and recording, and achieves a configuration that conforms to ergonomics.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A multifunctional dental mirror comprising:
an intraoral viewing mirror connected to a stem;
a base having a cover connected atop thereof, thereby forming a containment cavity within the base, wherein electronic components and circuits are disposed;
a water-repellent device comprising a ring disposed between the cover and the base, and a washer disposed between the cover and the ring:
an LED light-source device comprising at least one LED (light-emitting diode) and a light mount:
a camera device comprising a CCD (charge coupled device) photosensitive member and a control circuit board, which controls the LED light sources and camera cutover switches; the LED light sources project light directly onto the intraoral viewing mirror, and the camera device enables video image photography and recording of the video images.

2. The multifunctional dental mirror as described in claim 1, wherein the stem of the intraoral viewing mirror is affixed to a ring, and the ring can circumferentially rotate on the base to fix position of the stem.

3. The multifunctional dental mirror as described in claim 2, wherein an elastic piece provides an elastic catch force to clamp position of the ring on the base.

4. A multifunctional dental mirror, applicable for use when examining or treating the oral cavity or teeth, comprising a base connected to a stem having an intraoral viewing mirror, characterized in that:
light-emitting bodies are disposed within the base, and the light-emitting bodies project light directly onto the intraoral viewing mirror.
